(19) United States
(12) Patent Application Publication
(10) Pub. No.: US 2016/0117537 A1
(43) Pub. Date: Apr. 28, 2016

(54) Apparatus for Machine Vision and Recognition and Associated Methods

(71) Applicant: NADA Technologies, Inc., Austin, TX (US)

(72) Inventors: Timothy Carson Ewald, Austin, TX (US); Chung Hoo Tham, Singapore (SG)

(21) Appl. No.: 14/919,690

(22) Filed: Oct. 21, 2015

Related U.S. Application Data
(60) Provisional application No. 62/067,069, filed on Oct. 22, 2014.

(51) Int. Cl. G06K 7/10; G06K 19/06

(52) U.S. Cl. CPC G06K 7/10722; G06K 19/06009

(57) ABSTRACT

An apparatus includes a system for processing of an object that has at least one surface. The object has a machine readable code on the at least one surface of the object. The apparatus further includes a reading device. The reading device is positioned to read the machine readable code on the at least one surface of the object independently of the system for processing of the object.

### CROSS-REFERENCE TO RELATED APPLICATIONS

This application claims priority to, and incorporates by reference in its entirety for all purposes, U.S. Provisional Patent Application Ser. No. 62/067,069, filed on Oct. 22, 2014, titled “Apparatus for Machine Vision and Recognition and Associated Methods,” attorney docket number NADA002P1.

### TECHNICAL FIELD

The disclosure relates generally to machine vision or recognition and, more particularly, to apparatus for machine recognition of patterns or data, and associated methods.

### BACKGROUND

Machine vision or image/data recognition has been used increasingly in a variety of industries and areas of technology. Examples include manufacturing, quality control, robotics, automatic controls, etc.

Typically, machine vision systems use cameras mounted to facilitate capturing or acquiring images or video of desired areas, such as test or production lines or facilities. Image processing techniques are then used on the acquired images or video to inspect products, test progress or results, read data or codes on products or components, etc.

The results of the image processing may be used to take a variety of actions. Examples include controlling robots, performing manufacturing steps, performing testing, etc.

The description in this section and any figures corresponding to this section are included as background information materials. The materials in this section should not be considered as an admission that such materials constitute prior art to the present patent application.

### SUMMARY

A variety of apparatus for machine vision or recognition, more particularly, machine recognition of patterns or data, and associated methods are disclosed and contemplated. According to one exemplary embodiment, an apparatus includes a system for processing of an object that has at least one surface. The object has a machine readable code on the at least one surface of the object. The apparatus further includes a reading device. The reading device is positioned to read the machine readable code on the at least one surface of the object independently of the system for processing of the object.

### BRIEF DESCRIPTION OF THE DRAWINGS

The appended drawings illustrate only exemplary embodiments and therefore should not be considered as limiting the scope of the application or any claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 illustrates a read point according to an exemplary embodiment.

FIG. 2 illustrates a read point according to an exemplary embodiment.

FIG. 3 illustrates a read point according to an exemplary embodiment.

FIG. 4 depicts a network system according to an exemplary embodiment.

FIG. 5 an example arrangement according to an exemplary embodiment for calculating maximum camera frame speeds for a round object.

FIG. 6 depicts a read point camera design according to an exemplary embodiment.

FIGS. 6a and 6b show process flow diagrams for a read point camera according to an exemplary embodiment.

FIG. 7 shows a computer or computer system for information processing according to an exemplary embodiment that employs external image processing devices.

FIG. 7a shows an alternate configuration for a computer or computer system for information processing according to an exemplary embodiment where external image processing devices are not employed.

FIG. 8 depicts virtual associations related to the computer system of FIG. 7 according to an exemplary embodiment.

FIG. 8a depicts virtual associations related to the computer system of FIG. 7a according to an exemplary embodiment.

FIG. 9 depicts virtual associations for server processes according to an exemplary embodiment.

FIGS. 10, 10a, and 10b depict process flow diagrams according to exemplary embodiments.

FIG. 11 shows server scaling based on overall system load according to an exemplary embodiment.

FIG. 12 illustrates examples of variations of network communication or configuration according to exemplary embodiments.

FIG. 13 depicts a block diagram of an information processing system that may be used in exemplary embodiments.

FIG. 14 is process logic for a conventional apparatus.

FIG. 15 is process logic for a system according to an exemplary embodiment.

FIG. 16 shows an alternate process logic according to an exemplary embodiment.

FIG. 17 shows an example of conventional messaging.

FIG. 18 shows an example of messaging for a system according to an exemplary embodiment.

FIG. 19 shows an example of messaging for an alternate process flow according to an exemplary embodiment.

FIG. 20 depicts a conventional reading device.

FIG. 21. depicts an alternative scalable network server layout according to an exemplary embodiment.

### DETAILED DESCRIPTION

The disclosed concepts relate generally to machine vision or recognition. More specifically, the disclosed concepts provide apparatus and methods for machine recognition of patterns or data, and associated methods. One aspect of the disclosure relates to using such machine vision/recognition with semiconductor manufacturing equipment.

Another aspect of the disclosure relates to pattern recognition, such as identifying machine or computer readable codes on objects, such as round substrates or objects. The objects may exist in a desired location, such as locations where round objects are rotated for centering and alignment. As merely one application, exemplary embodiments may be used in the identification of semiconductor wafers while they are being manufactured.

The disclosed concepts provide a number of benefits, as described below in detail. In exemplary embodiments, no electrical or software interaction with the centering or alignment device or equipment need be used. This feature reduces the integration time/cost that is associated with implementations of relatively large scale. Thus, exemplary embodiments provide relative ease and relatively low cost of implementation.

In conventional approaches, the integration and implementation costs have been relatively high. The disclosed techniques entail mechanical mounting of the device and network setup, thus providing the benefit of relatively low integration cost, time, complexity, etc.

In exemplary embodiments, a network is used. The use of networks provides the benefit of allowing the user's identification data to be included in a central or centralized database (rather than scattered among various locations).

In exemplary embodiments, a leasing model may be used that provides a further cost benefit. Specifically, a cost benefit may be realized leasing the equipment/methods/processes to the user and setting up a co-located server that charges users on a per-use basis.

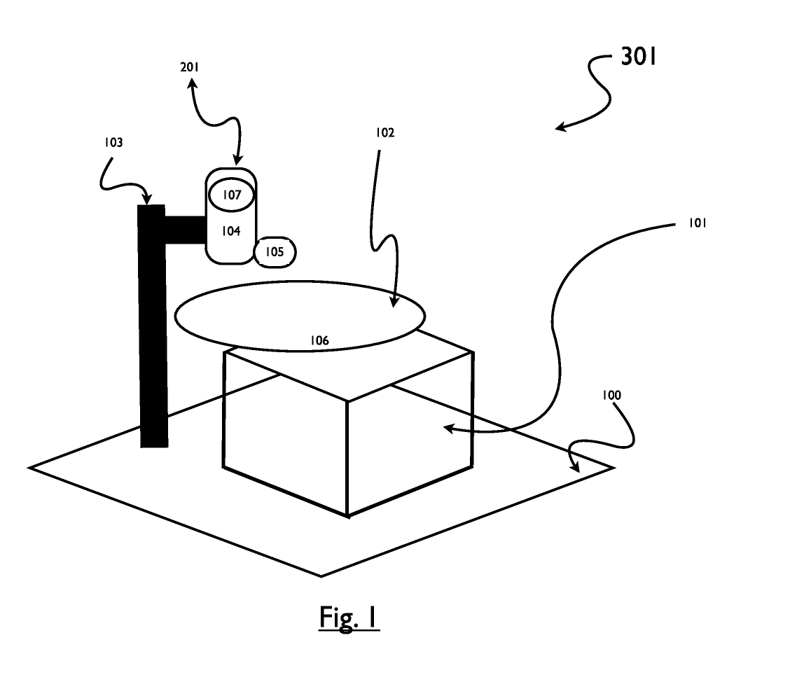

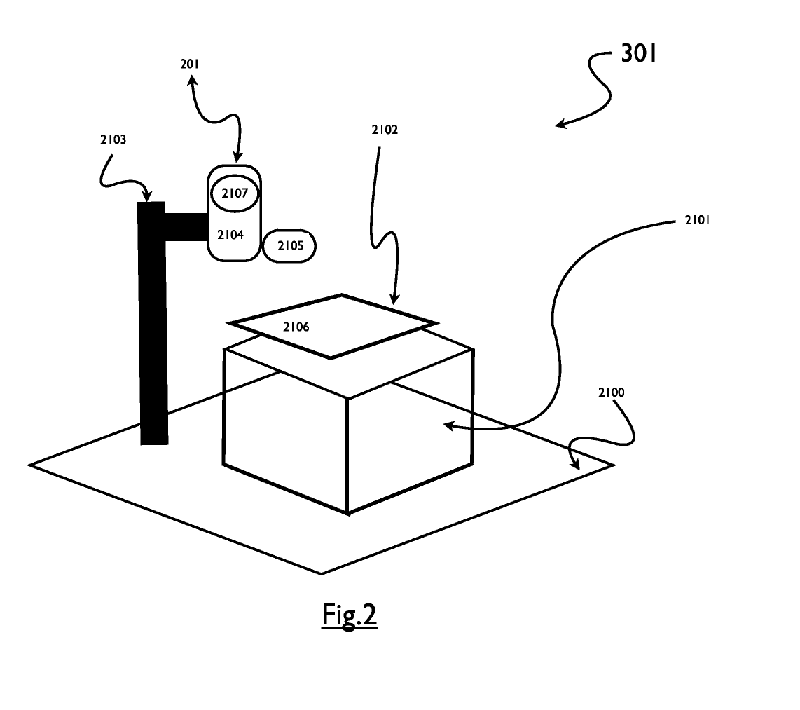

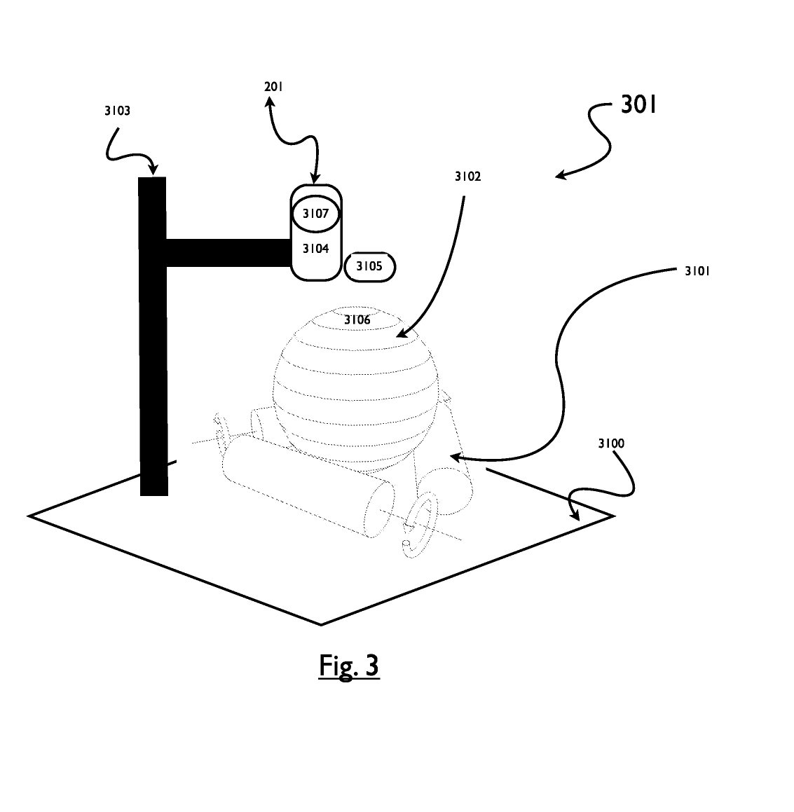

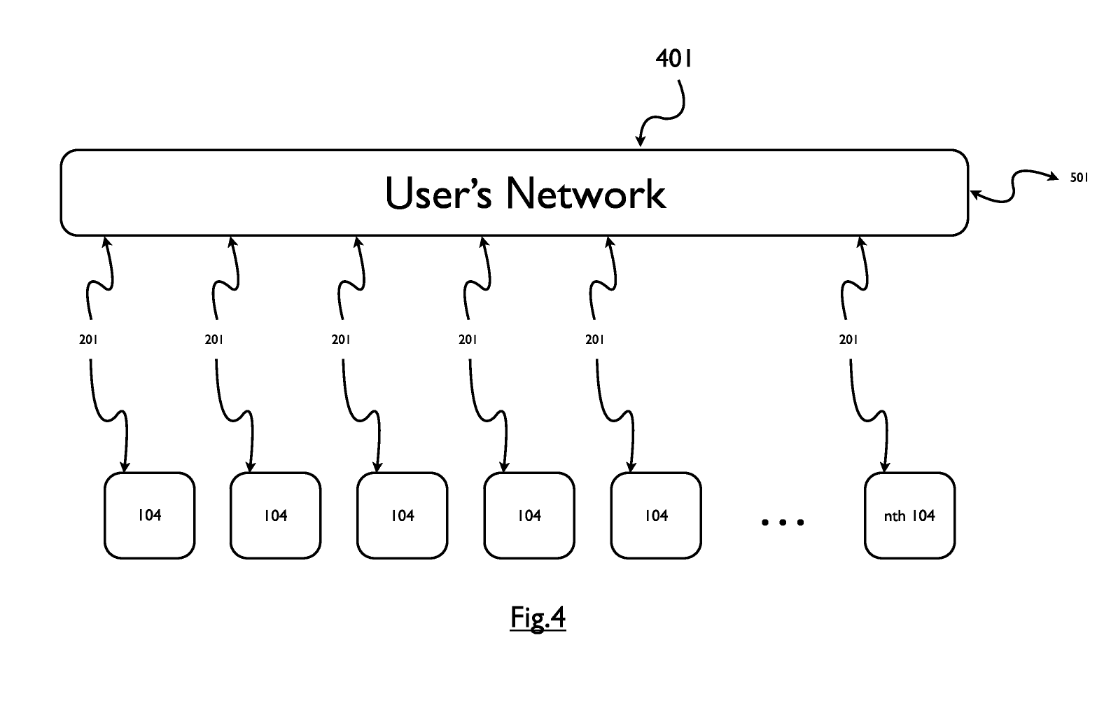

FIG. 1, FIG. 2, and FIG. 3 show an individual read point (or reading device) 301 according to exemplary embodiments. The embodiments in FIGS. 1-3 differ mainly in the type of substrate or object, type of centering/aligning device, and/or type of code. Thus, discussions of one of the embodiments in FIGS. 1-3 also applies to the other embodiments (bearing in mind the differences among the various embodiments). The read points are part of a larger networked system shown in FIG. 4. Read point 301 is any place in a manufacturing line where one or more objects (e.g., round substrate 102 in one of the examples shown and described) are centered and aligned. Other embodiments may include non-round substrates 2102, and three dimensional objects 3102, as described below in detail. Examples of non-round objects include elliptical objects, oblong objects, irregularly shaped objects, or polygon objects.

Referring to FIGS. 1, 2, and 3, a system, generally shown in FIG. 1 as 100, is any system used in the production, testing, measuring, or inspection (generally, manipulation or processing) of the round substrates 102. Device 101 is a part of system 100. It is a device that is used for centering and aligning the round substrate 102. Device 101 accomplishes this by spinning substrate 102 about its approximate center, finding the centroid and mechanically offsetting substrate 102 so that substrate 102 is both centered and aligned.

Note that system 100, device 101, system 2100, device 2101 and system 3100, device 3101 may be part of a user's existing manufacturing environment. They are existing components of production, testing, measuring, or inspection equipment used in the production of (102, 2102, 3102). Items 103, 104, and 105 are what are being added to create a 301 “read point” to benefit production of the user's product (102, 2102, 3102) being manufactured.

Other embodiments such as shown in FIG. 2. or FIG. 3 address the situation where non-round or objects are entailed or manufactured. Devices 2101 and 3101 are devices that are used for centering or alignment of non-round or objects during various processes, such as during a manufacturing process. The exemplary embodiment are generally discussed in the context of a manufacturing process. But as persons of ordinary skill in the art will understand, the disclosed concepts may be applied to any other process or manufacturing processes that involve aligning or centering of items.

Referring again to FIG. 1, substrate 102 has a machine or computer readable code or feature 106 included on a side or upper or lower surface of substrate 102. In exemplary embodiments, code 106 may be printed, inscribed, or otherwise included in or on substrate 102. In some embodiments, code 106 may be included on another object, such as a label, that is affixed to or included in or on substrate 102. Note that code 106 may be located on any surface or side of substrate 102. Bracket 103, camera 104, and light source 105 are shown in FIG. 1 as mounted for a situation where code 106 is on a top side surface of substrate 102. The mounting can be configured for any side or surface of substrate 102. If substrate 102 is found on more than one side, bracket 103 can be configured so several cameras 104 and light sources 105 units can be used.

In exemplary embodiments, code 106 may include encoded information. For example, in some embodiments, code 106 may include barcode information. As another example, in some embodiments, code 106 may include data matrix information. As yet another example, code 106 may include or have one ore more visible features that may be examined using image-processing techniques. Examples include feature presence detection or measuring dimension(s) (e.g., some critical dimension) on or of the feature.

In some embodiments, code 106 may include more than one piece or item of encoded information, and the items of information may use one or more than one type of data or encoding. For example, in some embodiments, code 106 may include more than one item of barcode information. As another example, in some embodiments, code 106 may include more than one item of data matrix information. As another example, in some embodiments, code 106 may include one or more item of barcode information and one or more item of data matrix information. As yet another example, code 106 may include one or more visible features that may be examined using image-processing techniques. Examples include feature presence detection or measuring dimension(s) (e.g., some critical dimension) on or of the feature. Note that in some embodiments, each feature may even use or relate to or entail a different image processing technique.

A read point unit (e.g., reader, acquisition device, etc.) is installed at the location shown. In the exemplary embodiment shown, the read point unit is made from a generic mounting bracket 103, a camera 104 (e.g., an intelligent networkable digital camera) with a light source 105 (e.g., strobe light source), and link or coupling mechanism to the user's network 201. The camera 104 is mounted in a manner such that when substrate 102 is being rotated, code 106 passes in front of camera 104.

Note that whether in the case of an object or a substrate, the mounting of camera 104 to bracket 103 is done in a manner that code 106 will eventually pass in front of camera 104 once it has been centered. Other geometric shapes (triangle, square, rectangle) entail positioning camera 104 over code 106 when it is radially aligned to camera 104. A three-dimensional shape such as a sphere, shown in FIG. 3, can also be configured in order to read code 3106. System 3100 causes code 3106 will pass in front of camera 3104 within a time limit, such as a prescribed or desired time limit, or a time limit that is acceptable. Typically, camera positioning depends on manner in which supplier of system 3100 aligns the object.

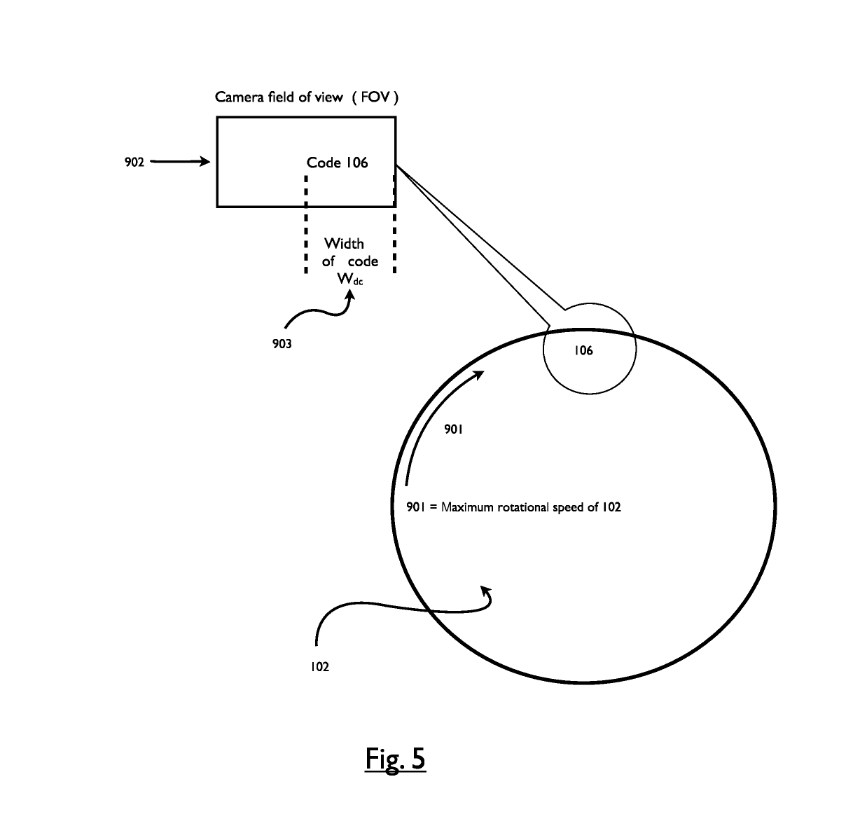

In exemplary embodiments, camera 104 is a programmable camera. In exemplary embodiments, camera 104 captures images at a frame rate greater than twice the speed code 106 is being rotated. This frame rate provides the capability for acquiring a full image (or a set of images) of code 106 while substrate 102 is rotating. In the case of round substrates, calculations that take into account the speed or rotation of object or substrate 102 may be performed as described below in detail. FIG. 5 shows an enlarged view of a round substrate 102. The arrangement in FIG. 5 facilitates calculating the maximum frame rate that camera 104 uses in the situation where round substrate 102 is rotating. Calculations shown below allow calculating frame rates for objects that are moving at relatively high speed. The calculations also help to understand the limitations of using a given network cameras for capturing data while substrate 102 is in motion. The calculations for a round embodiment, using the assumed values shown below, would be as follows:

$$F O V ( 902 ) = Safety Margin \times {W}_{d c} ( 903 )$$

$$Typical Safety Margin = 2$$

$$Desired image overlap = 2$$

$$Typical Wdc ( labeled as 903 in FIG . 5 ) = {1}^{″}$$

$$Example field of view ( F O V ) ( labeled as 902 ) = 2 \times {1}^{″} = {2}^{″}$$

$$Example Diameter of substrate 102 = {12}^{″}$$

$$Example Circumference of ( 102 ) = π \times D = 12 {π}^{″} = {37.68}^{″}$$

$$\begin{matrix}Number of F O V ( 102 ) per Circumference = \frac{Circumference}{F O V ( 902 )} \\ = {37.68}^{″} {/}^{″} 2 {\backslash}^{••} \\ = 18.84 , or when rounded , \\ = ∼ 19 frames\end{matrix}$$

$$FR max = \frac{frames}{1 rotation} \times \frac{maximum rotation}{second} \times image overlap$$

$$FR max = \frac{19 frames}{1 rotation} \times \frac{1 rotation}{second} \times 2$$

### Thus,

FRmax=38 frames per second. Of course, as persons of ordinary skill in the art will understand, the calculations illustrated and described above assume the values of various variables and parameters shown above. Similar calculations may be performed for other sizes of substrate 102, FOV, etc., as desired.

As noted above, in exemplary embodiments, camera 104 is programmable and running process, algorithm, or software (generally, “process,” which may alternatively be implemented in hardware, firmware, or a combination of the two or a combination of either or both with software, as desired) labeled as 107, 2107, 3107 in FIGS. 1-3, respectively. Thus, camera 104 may be programmed (e.g., software, firmware, programmable hardware, etc.) such that camera 104 detects the presence of substrate 102 in the field of view of camera 104. Camera 104 (e.g., the program included in or running in camera 104 will then strobe light source 105 at rates compatible with rotation speed of substrate 102, and capture video or image frames into a video or image file format.

More specifically, in some embodiments, the optics and focal length of camera 104 are predetermined so that code 106 occupies a percentage of the field of view of camera 104. For instance, in some embodiments, the optics and focal length of camera 104 are predetermined so that code 106 occupies 50% or less of the field of view of camera 104.

In exemplary embodiments, a variety of configurations of video or image frame rate may be used. For example, in some embodiments, the video or image frame rate is a parameter associated with all read points 301. As another example, in some embodiments, the video or image frame rate is a parameter associated with individual read points 301, or a set of the read points 301, etc. As another example, in some embodiments, each read point 301 has a unique video or image frame rate associated with that read point 301.

Generally speaking, in exemplary embodiments, the video frame rate is configured or calculated based on the rotational speed of substrate 102 such that at least two frames of code 106 are inside the field of view of camera 104. Also, the strobe rate of light source 105 is timed directly to the frame rate of camera 104 so that images captured do not blur.

As noted above, in exemplary embodiments, camera 104 is programmable running processes (e.g., software) 107, 2107, and 3107, respectively. In exemplary embodiments, the programmable camera allows for programmable light sources. Read point 301 in FIG. 1 is constructed in a manner that allows flexibility in exemplary embodiments. Similarly, in exemplary embodiments, the lighting configuration is also flexible, for instance, as flexible as possible for a given combination of components and circumstances. Similar considerations apply to other embodiments, such as the exemplary embodiments in FIGS. 2-3.

In exemplary embodiments, lighting includes dual “light field” source types. Dark field (reflective off axis illumination) light source may be used, as desired. Bright field (on axis illumination) light source may be used, as desired. The choice of lighting colors is also flexible, and generally should be as flexible as possible for a given configuration of components and circumstances. Surface colors of objects being viewed will vary and the characteristic of videos and images produced depend on the color of light being used for illumination, as persons of ordinary skill in the art will understand. Thus, in some situations, omni-color light sources are used, such as omni-color light emitting diodes (LEDs).

Typical product names for omni-color LEDs are “neo-pixel” or “dot-star,” which may be used in exemplary embodiments. Other types of LED may be used, as desired, as persons of ordinary skill in the art will understand. The omni-colored LEDs typically use a multi-wire bus communication protocol to set their intensity and color. This bus protocol may be implemented as a process (e.g., software) on the programmable camera 106. In some embodiments, the default camera configuration could be such that a specific selection of light color and light field may be always used. The configuration may also be such that the color and light field type are varied during a period (or the entire time) that video is being captured. Alternatively, a configuration may be used where the network server informs the read point (e.g., 301) upon detection of the object (e.g., 102, 2102, 3102) which color and which light field to use.

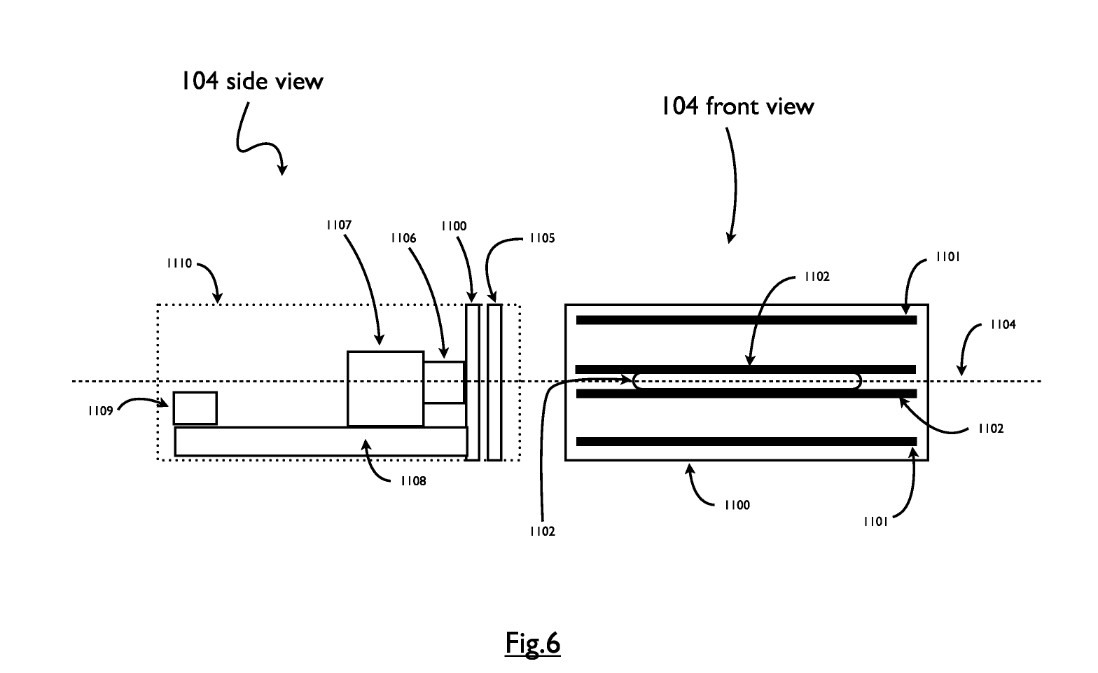

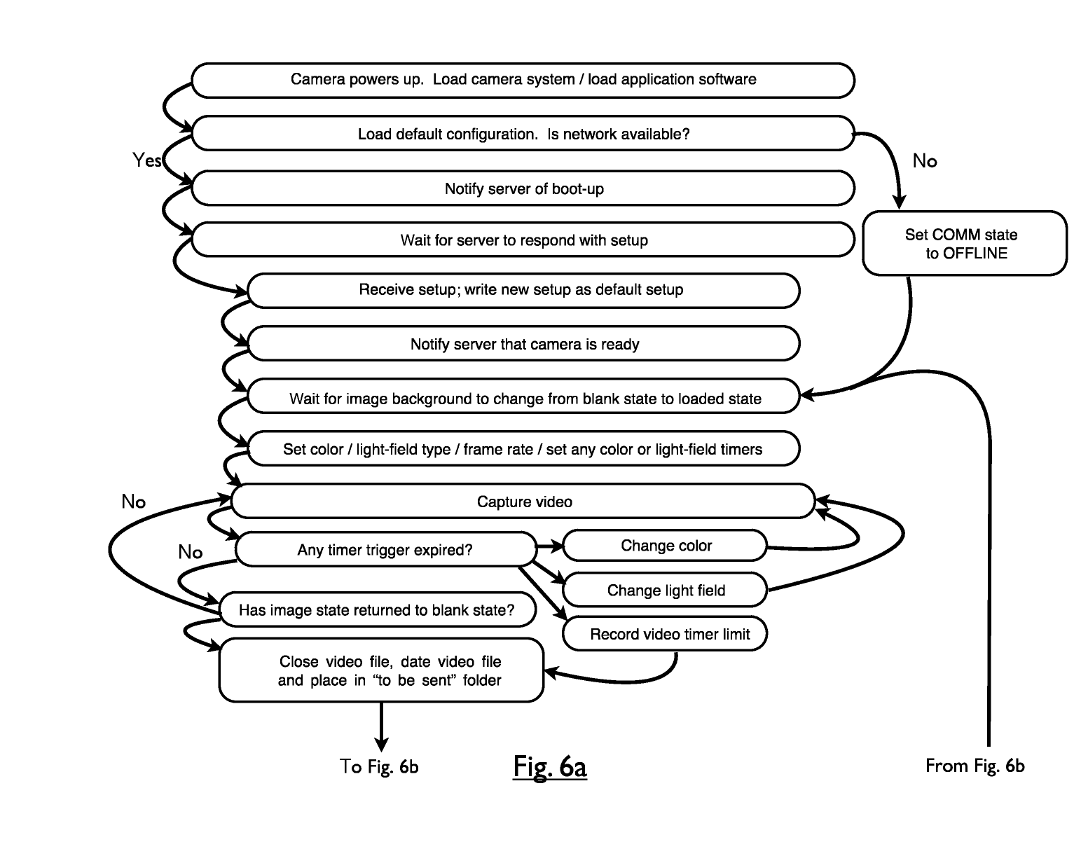

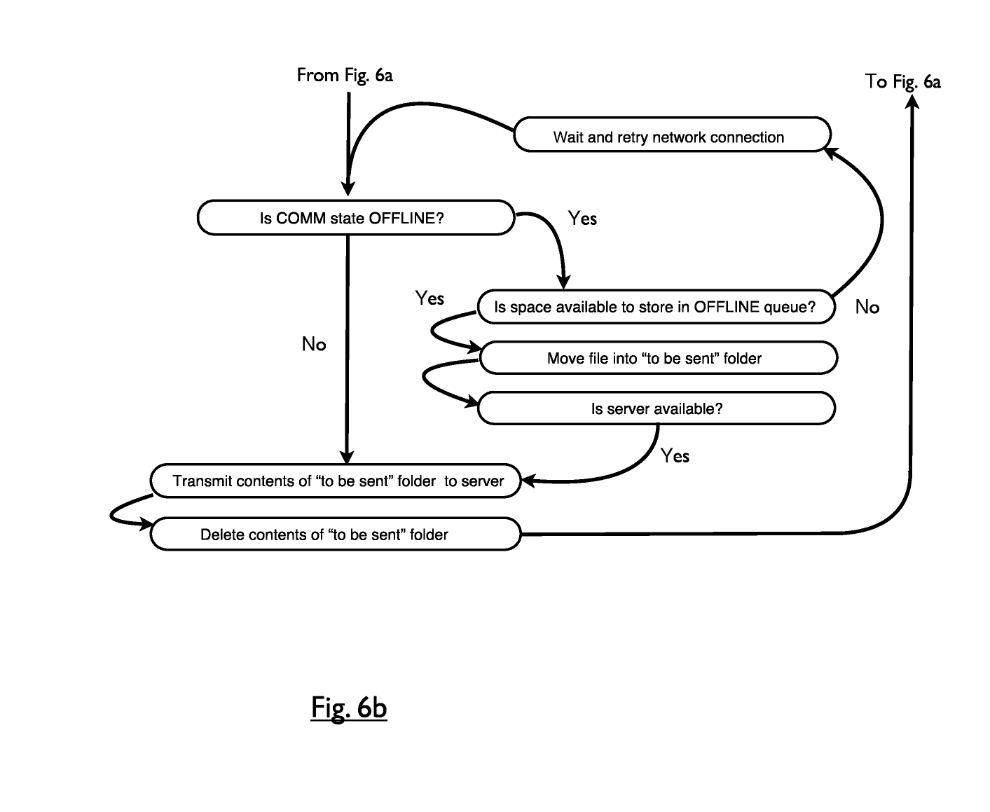

FIG. 6 depicts a design of camera 104 according to an exemplary embodiment. The design shown in FIG. 6 may be used in the exemplary embodiments in FIGS. 1-3, as desired. Referring again to FIG. 6, printed circuit board (PCB) 1100 is used for the circuit that provides illumination. PCB 1100 has mounted on it a series of rows of omni-colored LEDs. Two rows of LEDs 1101 that are far off the optical axis 1104 are shown in FIG. 6 as an example. These LEDs provide the “dark field” style of lighting illumination. Two rows of LEDs 1102 are placed relatively close (e.g., as close as possible in a given implementation) to optical axis 1104. These LEDs provide “bright field” 1103 in a narrow slit or hole that is part of PCB 1100.

Camera lens 1106 is mounted relatively close (e.g., as close as possible in a given implementation) to PCB 1100 so that PCB 1100 does not obscure the image that is formed in camera 1107. In exemplary embodiments, camera 1107 may be a commercially available camera, for instance, charge coupled device (CCD), complementary metal oxide semiconductor (CMOS), as desired, or other type of camera that is readily available. A variety of considerations may be taken into account in selecting camera 1107, such as the camera being reliable, affordable, and have a pixel count that is acceptable to a variety of image processing devices and processes (e.g., software) used to process the images camera 1107 generates.

Computer 1108, implemented using a PCB, for example, provides local processing, computing, and communication to meet the needs of a read point camera. In some embodiments, computer 1108 has sufficient computing power to provide image-processing techniques such as OpenCV. Generally speaking, in exemplary embodiments, computer 1108 includes a central processing unit (CPU), memory (e.g., random access memory), and flash memory for operating read point processes, e.g., booting read point operating systems and application software, and flash memory for local storage of video clips or images, as desired. Connector 1109 is an external connector (or connectors) for network (e.g., Ethernet) and power connections. Computer 1108 is coupled to PCB 1100 and provides control over the omni-color LEDs. Cover 1110 encloses the entire camera device. Material 1105 is an opaque material that is mounted in front of the LED rows to help defuse the lighting and avoid bright spots in camera image, as desired.

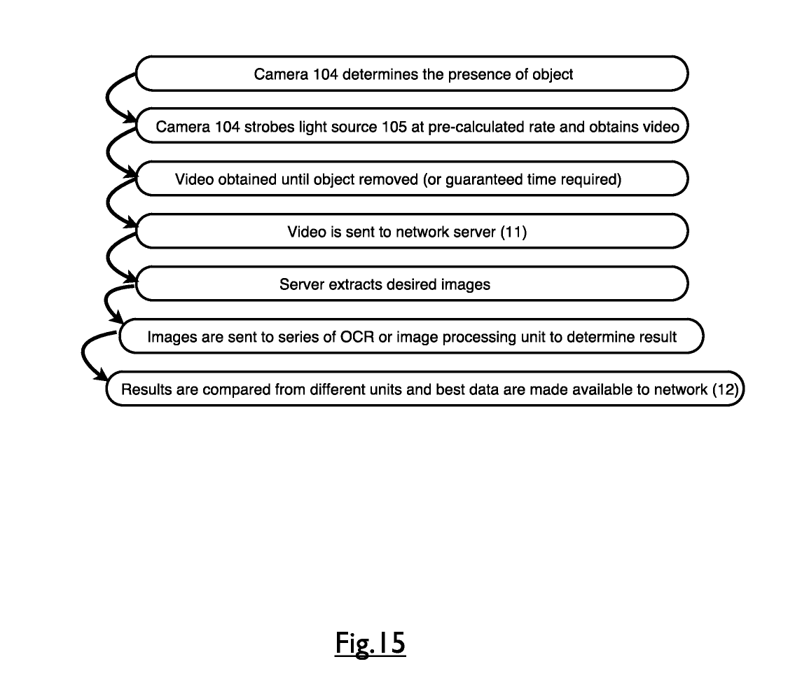

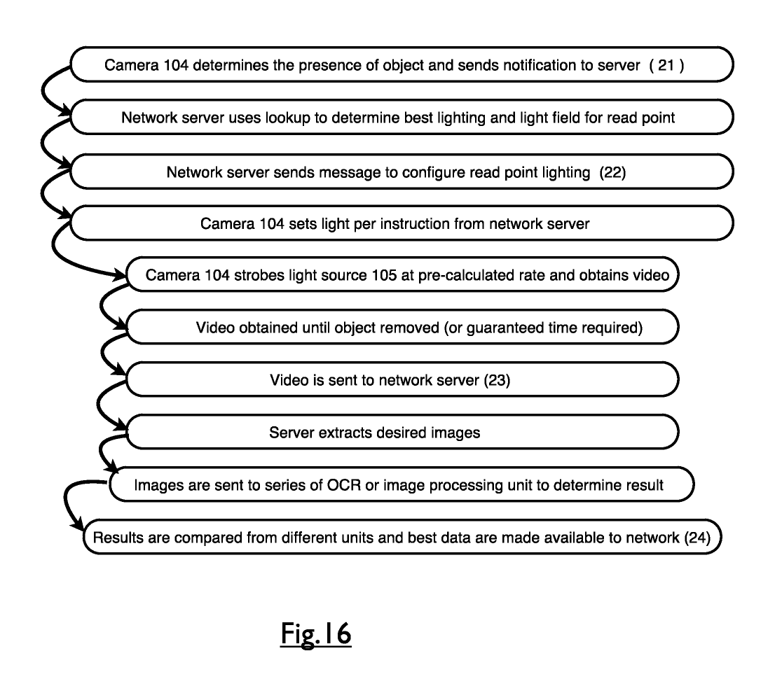

FIGS. 6a and 6b show process flow diagrams for a read point camera according to an exemplary embodiment. (Note that FIG. 15 and FIG. 16 depict logic and messaging orders, as described below).

As noted, camera 104 may capture video or images. The video or image may stored, e.g., in file(s) stored locally in camera 104 and placed in queue to be sent to network coupled to camera 104 at point or link or coupling mechanism 201 (e.g., the camera may have in exemplary embodiments a mechanism or port for coupling to a network).

FIG. 4 shows read point cameras 104 coupled to a network 401 according to an exemplary embodiment. In some embodiments, network 401 may constitute a pre-existing network, such as the user's network. In some embodiments, network 401 may be a dedicated network, as desired.

Network 401 has a point or a mechanism for coupling to data processing equipment, such as a computer system or computer (not shown). In exemplary embodiments, the computer system may process the video or image data further. For example, the computer system may convert the video or image data into American Standard Code for Information Interchange (ASCII) data created from images stored in the video or image files. The results of the conversion, e.g., ASCII data, may be stored in one or more files and provided to the user, as desired.

Note that ASCII data constitute merely one example of the data that the computer system may generate. In exemplary embodiments, other data formats may be accommodated, as desired, by using appropriate or desired processes to convert the video or image data into data having the desired format. Example for data formats that may be used include ASCII, binary, and image data files in various binary formats, such as BMP, JPG, TIFF, and PNG, as persons of ordinary skill in the art will understand.

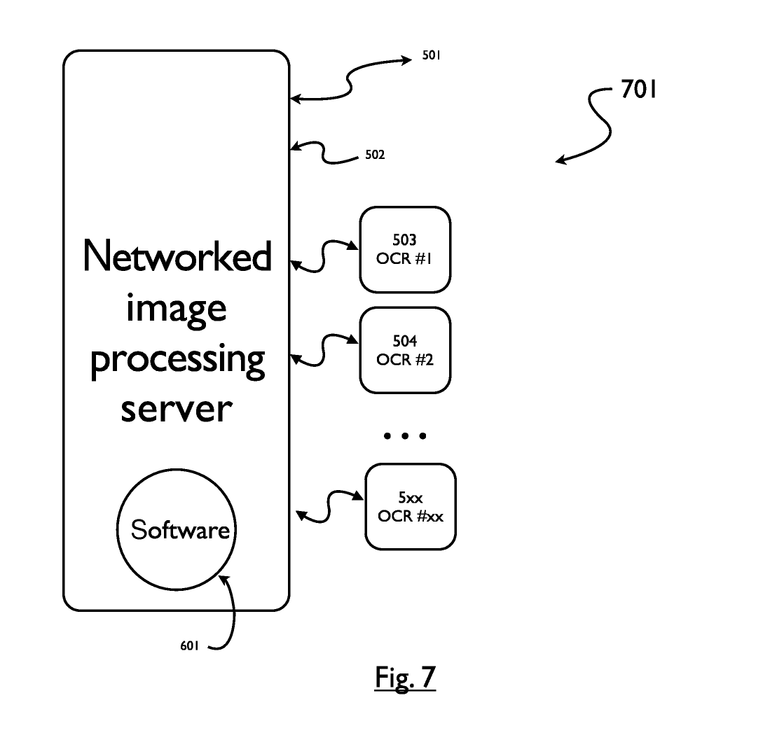

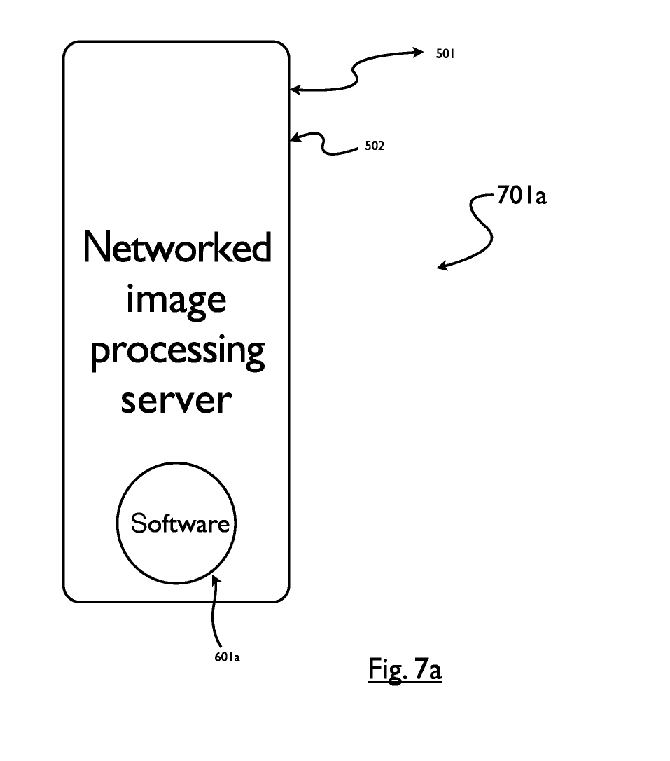

FIG. 7 shows a computer or computer system 701 for information processing according to an exemplary embodiment. As noted above, in exemplary embodiments, computer system 701 converts computer or machine-readable codes found in the video or image files acquired by read point(s) 301 (or other read points, such as FIGS. 2-3) into desired data, such as ASCII data.

Referring again to FIG. 7, in the embodiment shown, computer system 701 runs a program or programs or instructions stored in storage device 601 that separate the video or image files into images that contain computer or machine-readable data (data code images) and images that do not. The images that contain computer or machine-readable data are then transferred to a desired number of optical character recognition (OCR) devices (labeled as 503, 504, . . . 5XX, where “XX” depends on the number of OCR devices used).

Image processing server 502 supervises the provision of data received from network 401 (not shown) via coupling mechanism 501 to OCR devices 503-5XX. As noted above, OCR devices 503-5XX convert the image data into desired data, such as ASCII data.

In some embodiments, OCR or image processing devices 503-5XX may constitute standard or readily available commercial or general-purpose or off-the-shelf or non-custom or non-customized OCR or image processing devices. In other words, OCR or image processing devices that have not been customized for a particular end-use, such as use in exemplary embodiments, may be used. FIG. 7a shows an alternate method where separate image processing devices 503-5xx are not employed. The OCR or image processing functions reside as processes (e.g., software processes) on image processing server 502.

By using standard readily available commercial OCR or image processing devices, the relatively complex existing technology for reading OCR/Barcode/Data Matrix codes or image processing and the development done in those devices and areas may be leveraged (rather than recreated or a specific technology developed). Consequently, the cost and/or complexity associated with implementing various embodiments may be lowered.

Furthermore, using an undetermined or desired number of OCR or image processing devices provides flexibility as some OCR or image processing devices or readers provide benefits with processing particular types of data. Additionally, using several OCR or image processing devices to read or manipulate the same data provides an additional level of confidence that the data/results (e.g., ASCII data) are correct and properly represent the contents of code 106.

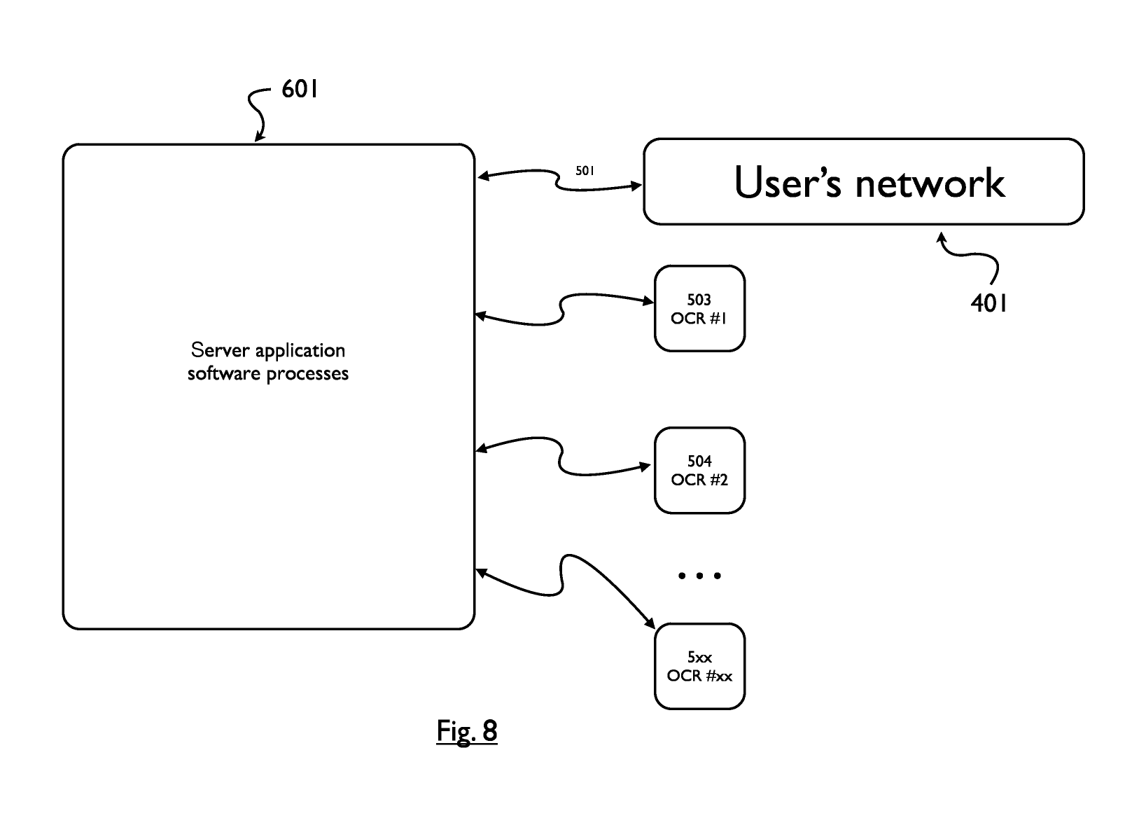

FIG. 8 shows the virtual associations or connections used for software running on computer system 701. In the embodiment shown, the software uses software processes indicated as 602. The software processes 602 provide at least the following functionality: (1) manage incoming video or image files, associate video or image files to the network addresses from which they were received or from which they came; (2) manage the queue that separates data code images from video or image files; (3) send data code images to corresponding or responsible OCR/Barcode/Data matrix devices 503-5XX; (4) receive data in a desired format, such as ASCII data, from devices 503-5XX; and (5) make final data reports available to the user, e.g., to other devices or systems via network 401, stored in files, etc. FIG. 8a is an alternate embodiment where separate image processing devices are not employed. Individual software processes 602a-6XXa are used as desired to accomplish image processing.

The choice to use separate devices 503-5XX (FIG. 7. and FIG. 8.) or processes (e.g., software or software only processes 602a-6XXa (FIG. 7a. and FIG. 8a.) is partially the choice of system end user and of the complexity of the OCR or image processing that is to take place. In exemplary embodiments that involve reading OCR codes on semiconductor wafers during semiconductor fabrication, the choice may be based on the ability of OCR processes (e.g., software-based algorithms) versus the ability of OCR processes running on OCR device hardware specifically designed to decode OCR for semiconductor wafers.

Generally speaking, OCR devices that are specifically designed for this purpose will generate the best results. In situations with more relaxed specifications (e.g., not as stringent with respect to the generated results), a simple image processing task (like determining if an object is found to be present or not), processes such as software or software only based algorithms may be adequate and adding external image processing devices may be omitted.

A software only (602a-6XXa processes) embodiment provides the advantages of lower cost and lower overall system complexity. On the other hand, using separate devices 503-5XX provides better or higher quality data results. Thus, a variety of choices of system implementation exist, depending on factors such as cost, complexity, desired specifications and/or performance, as persons of ordinary skill in the art will understand.

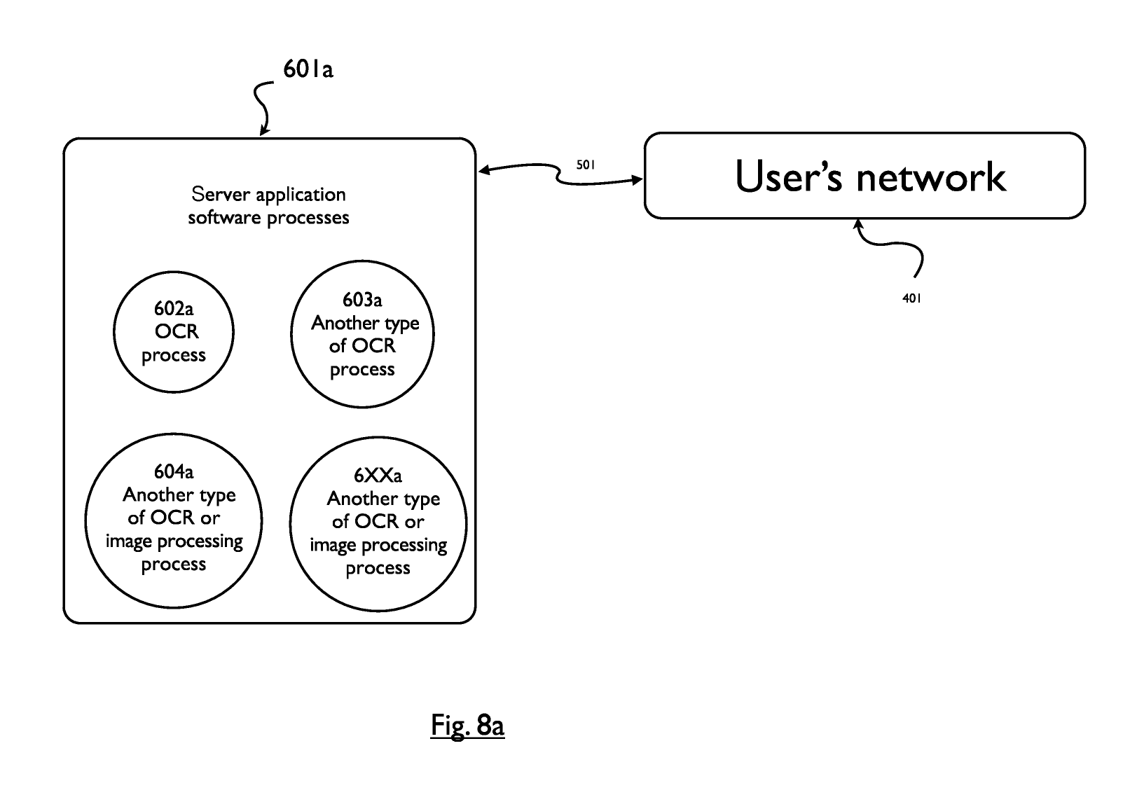

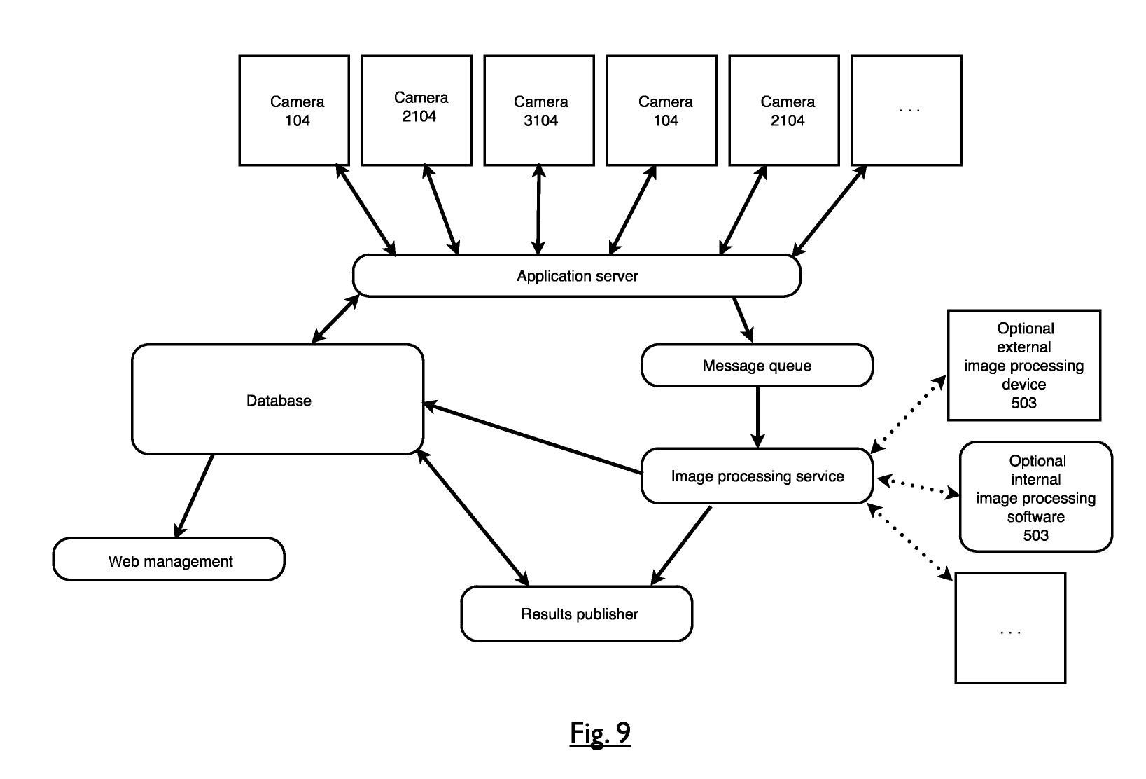

FIG. 9 shows a virtual representation of processes that would be running on a physical server 502 according to an exemplary embodiment. The application server manages communication to the read point cameras including video clip transfers and camera configuration. The database server holds over system status, camera configuration, processing results and logging information. The message queue is a process to compensation for timing differences in rates of which data can be coming in and rates that data can be processed. The queue should be empty under normal or ideal circumstances, but is used for higher traffic times so that no message or data are lost.

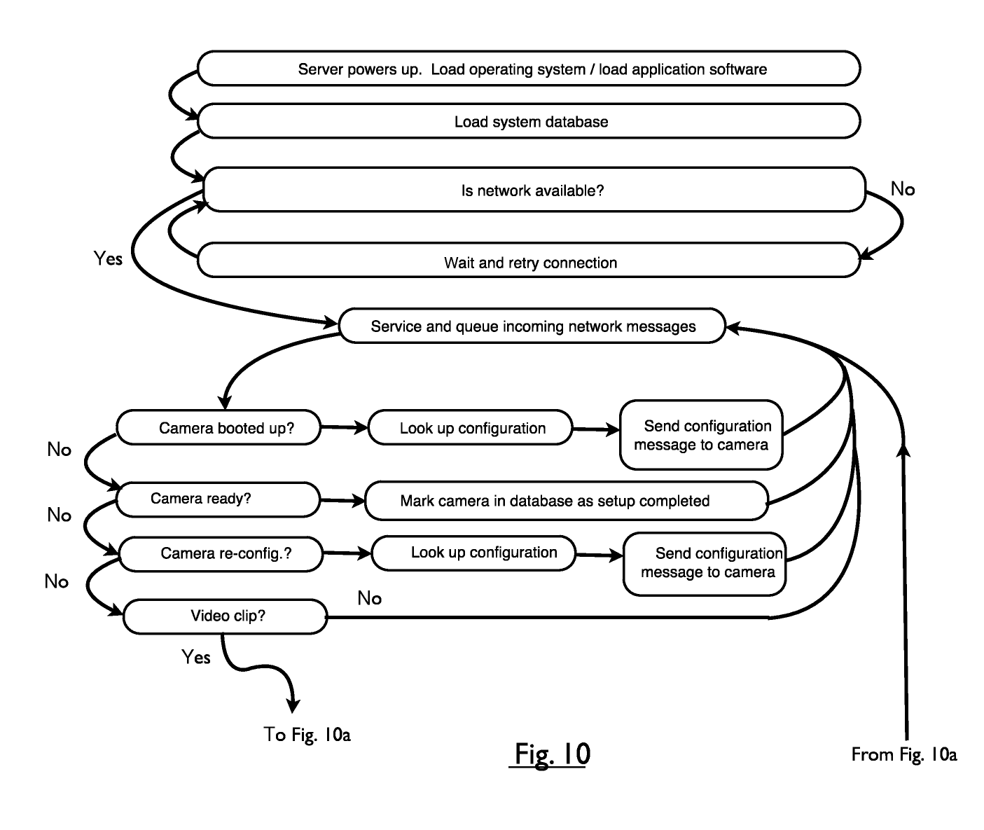

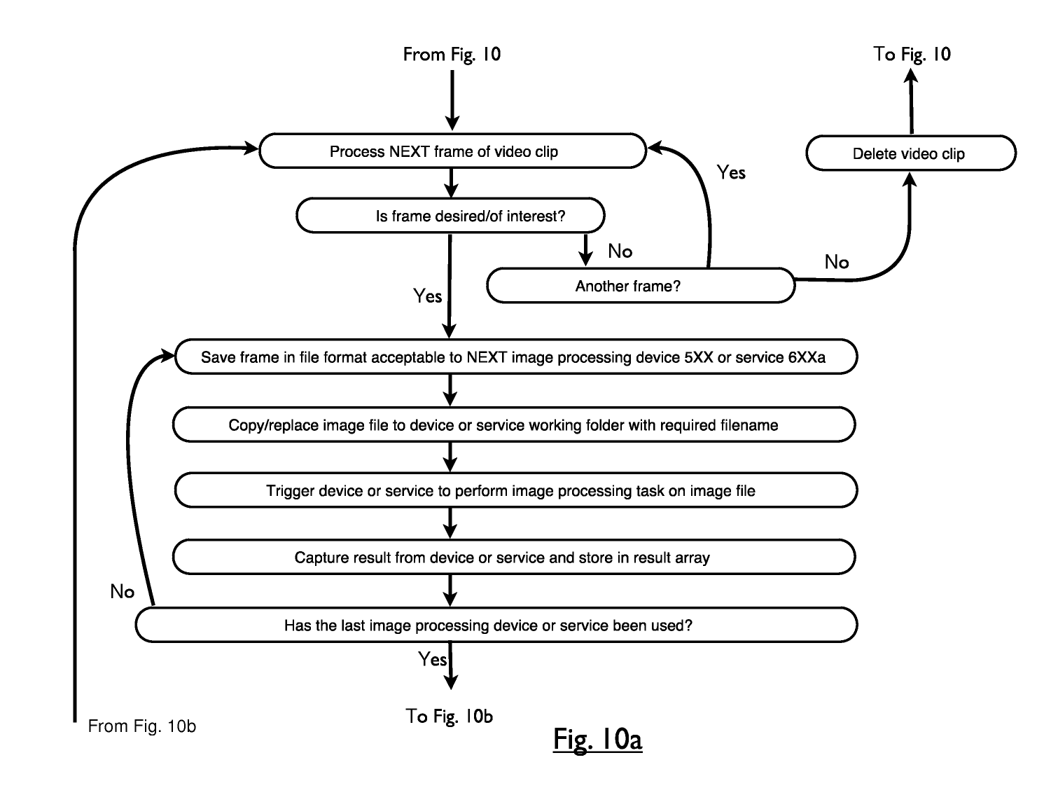

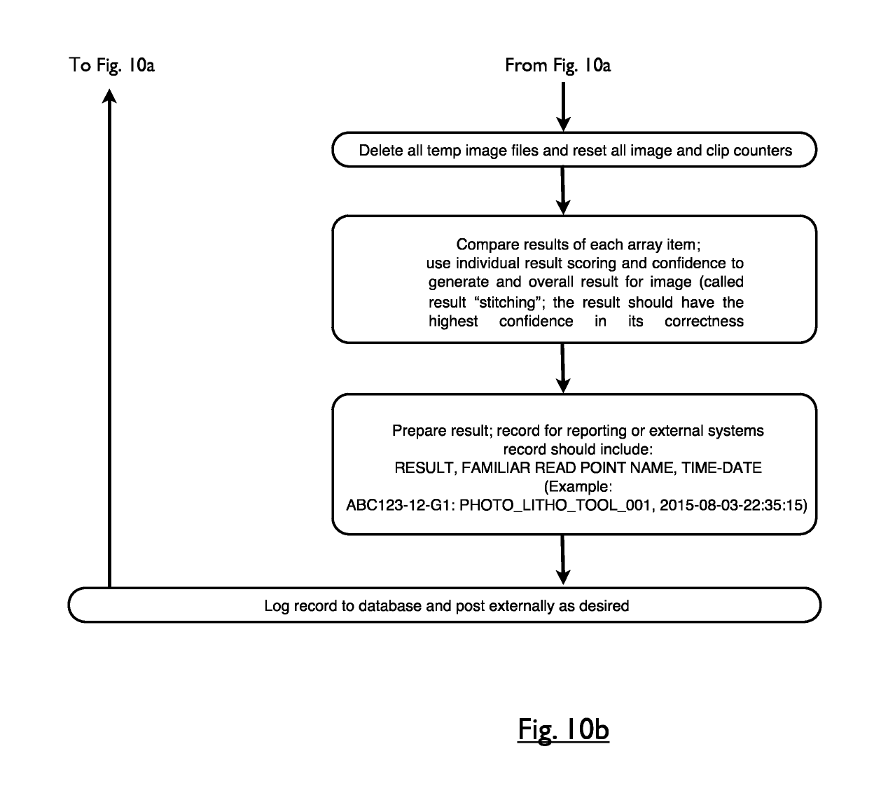

The web server or management supports a user interface that allows viewing and setting of user definable parameters. The image processing service breaks up or divides video or image clips or files into individual frames so the image processing devices 5XX or services 6XXa can decode them. The result publisher is a process for determining the best or higher quality or highest quality result and making the data available to the user's external services. FIGS. 10, 10a, and 10b illustrate process flow diagrams for the processes (e.g., software operation) performed according to exemplary embodiments.

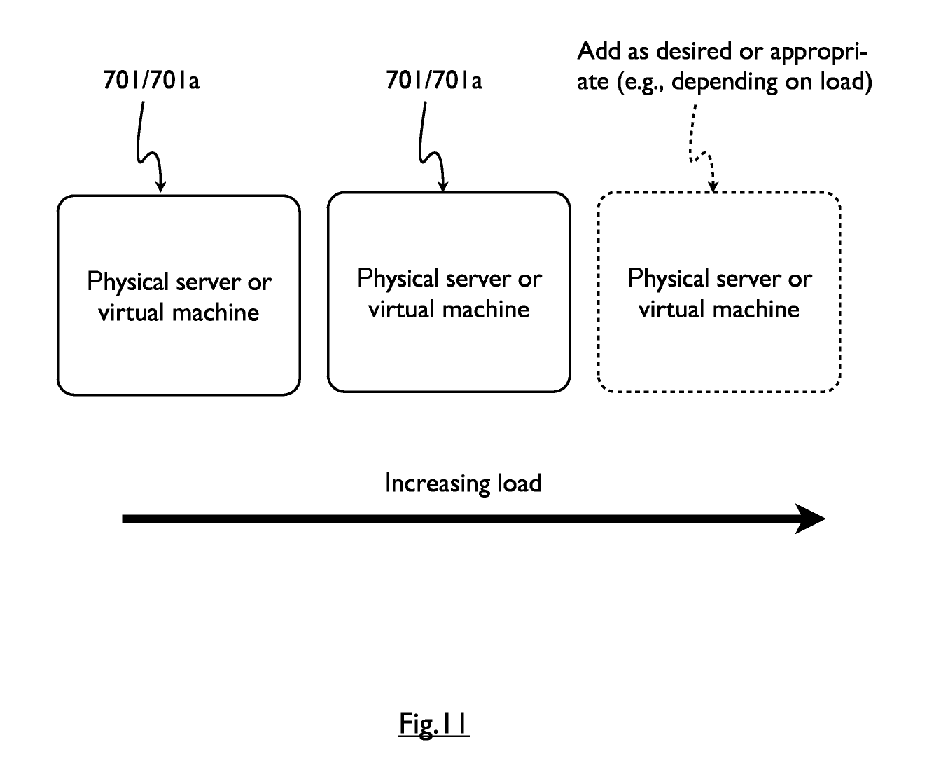

Processes (e.g., software processes) 601/601a shown in FIG. 9 can be scaled as needed. Typically, demand on the message queue dictates whether additional server processing capability is deployed or used. Processes 601/601a may be implemented by using one physical server or multiple servers, as desired. Alternatively, they may be realized on physical servers and/or on virtual machines depending on the load and the users network. The design of processes 601/601a is such that each piece or process may be independently and horizontally scaled. FIG. 11 shows an example of scaling according to an exemplary embodiment.

Software processes 601/601a also include provisions for various parameter associations. For example, in some embodiments, software processes 601/601a provide an association between network addresses and names. In networks, such as network 401, read point units typically have a network address, such as 127.0.0.99. Software processes 601/601a may provide an association between the address and a name or mnemonic that may be more meaningful or friendly to the user. For instance, software processes 601/601a may associate network address 127.0.0.99 with the name “PHOTO_LITHO_TOOL_001” for one of the read point units 301.

As noted, in some embodiments, one or more final data reports may be generated and provided to the user, as desired. The final data reports may include a variety of items of information or data, as desired. Examples include: the time substrate 102 is found at read point 301, the data read or feature measured or whatever is identified from code 106, e.g., the ASCII data equivalent of code 106, the color that was used, the light-field type used, the associated meaningful “friendly” name of where data were read from (e.g., “PHOTO_LITHO_TOOL_001”), a confidence level of how well the reader or OCR devices translated or converted the image data to output data (e.g., ASCII data), and even the images used for reading. The report may me made available to the user by computer system 701 (e.g., software processes 601/601a) in whatever way or format or manner the user desires or deems useful.

An overall strategy that evaluates the quality of result data can be employed as part of 601/601a software processes. This strategy would determine if a particular color or light-field is optimal or appropriate at or for a particular read point. If a specific light-field and color are found over time to have higher or the highest success rate, then one or more read point configurations may be set to this optimal setting.

In some embodiments, processes 601/601a operate using or on a database. The database may include tables with following template records:

IP to friendly name table

| | | |
|---|---|---|
| record # | IP address | friendly name |

Read point configuration table

| | | | | | | |
|---|---|---|---|---|---|---|
| record | friendly | lighting | default | default | dynamic | dynamic |
| # | or IP | mode | color | light field | color | light |
| | address | | | | setting | setting |

Results table

| | | | | | | | | | | |
|---|---|---|---|---|---|---|---|---|---|---|
| record | friendly | date | time | result | confidence | image device | light | color | field | image |
| # | name | | | | of result | or process | mode | used | used | used |
| | or IP | | | | | used | used | | | |

System log table

| | | | | | |
|---|---|---|---|---|---|
| record # | friendly | date | time | system log message | debug data |
| | name or IP | | | | |

The database employed may be but are not limited to an SQL type. An example of an open-source SQL database that is freely available is MYSQL. The tables depicted tables above may have maintenance available to them from the web interface. Maintenance items may include but are not limited to: editing individual an record or multiple records, deleting records, creating new records, backing up tables, restoring tables, and deleting entire table contents.

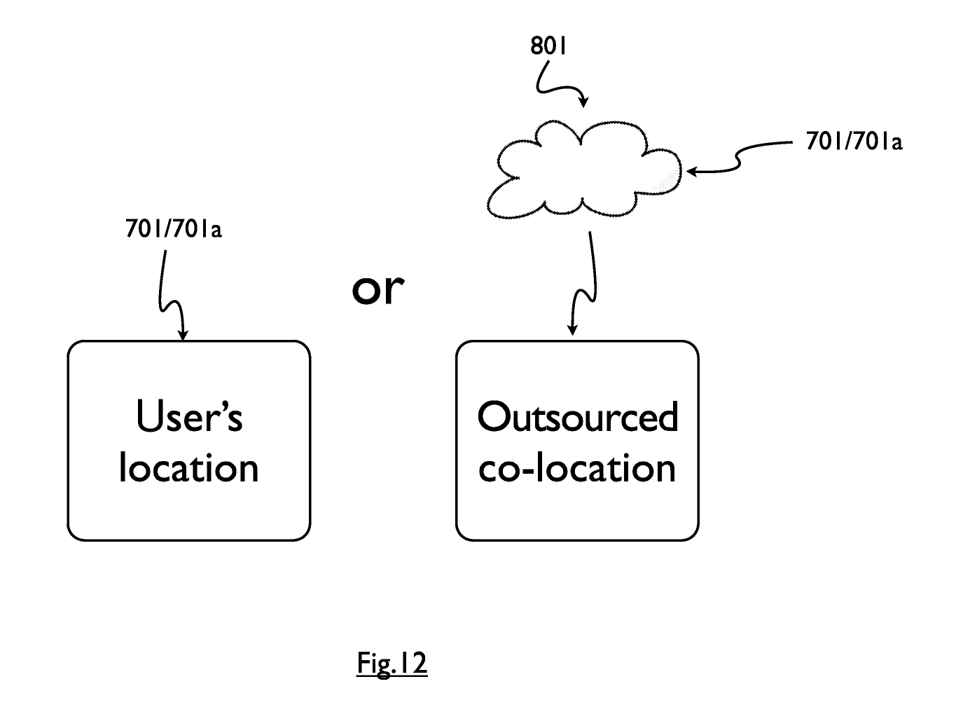

In exemplary embodiments, a variety of network communication and/or configurations may be used. By way of illustration, FIG. 12 shows two examples.

In the configuration shown on the left side of FIG. 12, computer system 701 is located at the user's site or location, e.g., where network 401 (not shown) is located. In some embodiments, computer system 701 may act as a server for network 401, as desired.

In the configuration shown on the right side of FIG. 12, computer system 701 is located outside the user's site or location. In this scenario, some or all of the functionality of computer system 701 may become co-located and the services of computer system 701 would be part of a cloud or network/computing environment 801.

A remote or outsourced co-located computer system or server 802 may provide services to the user on as-needed cost basis. For example, system 802 might charge the user for the images it reads in order to reduce the user's up-front installation/implementation costs, and/or as a method of providing the supplier with a long-term income source for the services provided. In some embodiments, system 802 might serve as a foundation or model for a large-scale pay-as-you-go (or pay per service) image processing service.

Although exemplary embodiments are described in connection with round objects, such as substrates, in a particular setting, such as centering and aligning substrates, other implementations, uses, realizations, and alternatives are contemplated as within the scope of the disclosure. Furthermore, in addition to semiconductor manufacturing, the disclosed concepts may be applied to other situations, such as testing, manufacturing, parts processing, etc.

In some embodiments, a network camera, such as a standard readily available commercial network camera or non-custom or non-customized network camera may be used at each read point unit to provide live video or image feeds to a video or image server. The video server would capture videos from each read point unit and process the data similarly by finding the data code and providing the information to OCR devices for reading or conversion.

Such embodiments, by virtue of relatively high frame rates, may generate a relatively large amount of network traffic (e.g., due to live feeds). Thus, in some embodiments, a separate or dedicated network may be used. Such embodiments therefore provide a trade-off, depending on the user's specifications, budget, desired performance, etc., between performance and cost.

Note that in such embodiments strobe lighting synchronized to rotation speed is used. A non-programmable camera at the read point unit serving the video or image information would also be used to strobe to avoid burred images. In some embodiments, a light strobe controller at each read point unit may be used (e.g., a separate connection to a light strobe controller at each read point unit).

Note that rather than using readily available commercial cameras, special-purpose or custom or customized cameras may be used. For example, a camera may be used with a universal serial bus (USB) interface may be used. In such a situation, a network adapter that can accept information via the USB interface and communication via a network, such as user's network 401, may be used. The choice of camera depends on the details of a given implementation, such as budget, cost, available technology, desired performance, specifications, etc., as persons of ordinary skill in the art will understand.

In some embodiments, rather than using separate devices running their own associated software, OCR/Barcode/Data Matrix software may be used on a server, such as a server on the user's network 401. For instance, readers that are reading non-degraded data codes can be used. One application, semiconductor wafer reading, typically involves dealing with degraded code. (The manufacturing of the wafers destroys the codes.) In such situations, specialized OCR/Barcode/Data matrix readers, which are typically separate devices, may be used.

According to one aspect of the disclosed concepts, one may perform, run, or execute the disclosed processes, algorithms, methods, or software on computer systems, devices, processors, controllers, etc. Examples include computer system 701, computer 1108, file servers, video or image servers, etc., as described above in connection with exemplary embodiments.

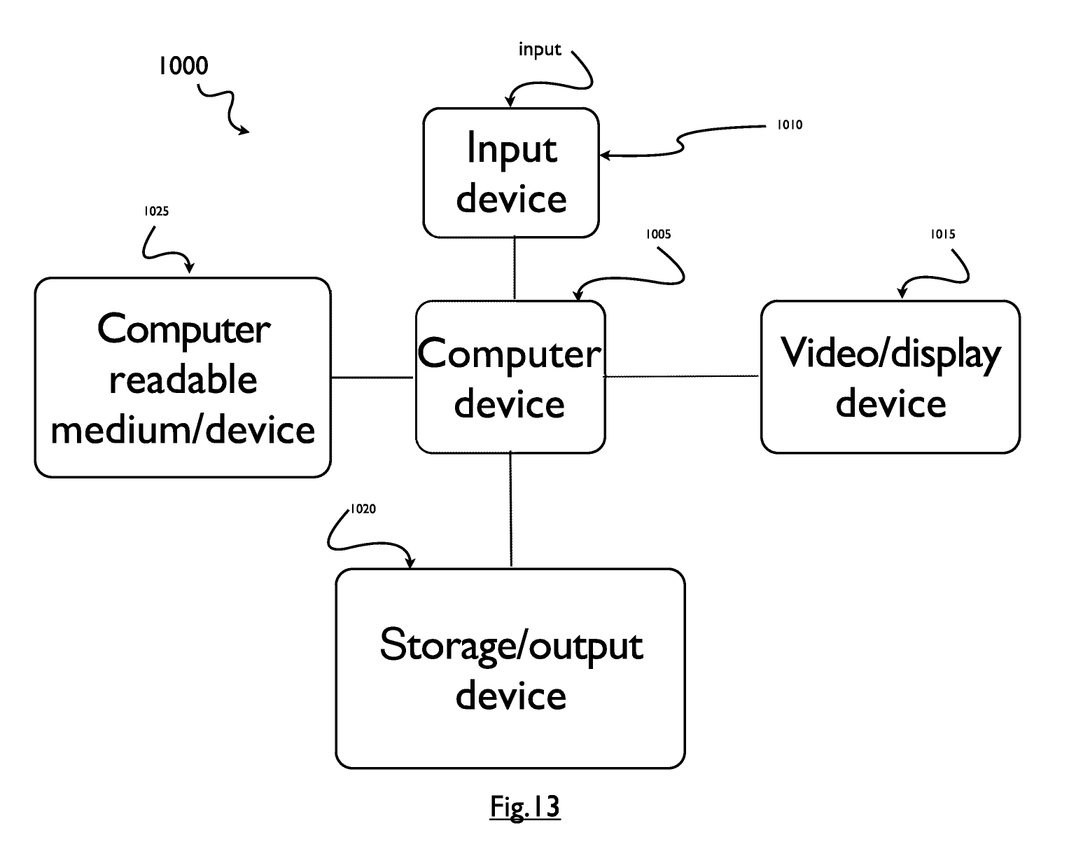

FIG. 13 shows a block diagram of an exemplary system 1000 for processing information that may be used in exemplary embodiments. For example, in some embodiments, system 1000 may be used to realize or implement one or more of computer systems 701, computer 1108, file servers, video or image servers, etc. As another example, system 1000 may be used to run software processes 602. System 1000, or modifications or variations of it as persons of ordinary skill in the art will understand, may be used to run or perform processes used in the disclosed concepts.

Referring again to FIG. 13, system 1000 includes a computer device 1005, an input device 1010, a video/display device 1015, and a storage/output device 1020, although one may include more than one of each of those devices, as desired. Computer device 1005 couples to input device 1010, video/display device 1015, and storage/output device 1020. System 1000 may include more than one computer device 1005, for example, a set of associated computer devices or systems, as desired.

Typically, system 1000 operates in association with input from a user. The user input typically causes system 1000 to perform specific desired information-processing tasks, including the functions, processes, programs, methods, etc., described above. System 1000 in part uses computer device 1005 to perform those tasks. Computer device 1005 includes information-processing circuitry, such as a central-processing unit (CPU), controller, microcontroller unit (MCU), etc., although one may use more than one such device or information-processing circuitry, as persons skilled in the art would understand.

Input device 1010 receives input from the user and makes that input available to computer device 1005 for processing. The user input may include data, instructions, or both, as desired. Input device 1010 may constitute an alphanumeric input device (e.g., a keyboard), a pointing device (e.g., a mouse, roller-ball, light pen, touch-sensitive apparatus, for example, a touch-sensitive display, or tablet), or both. The user operates the alphanumeric keyboard to provide text, such as ASCII characters, to computer device 1005. Similarly, the user operates the pointing device to provide cursor position or control information to computer device 1005.

Video/display device 1015 displays visual images to the user. Video/display device 1015 may include graphics circuitry, such as graphics processors, as desired. The visual images may include information about the operation of computer device 1005, such as graphs, pictures, images, and text. Video/display device 1015 may include a computer monitor or display, a projection device, and the like, as persons of ordinary skill in the art would understand. If system 1000 uses a touch-sensitive display, the display may also operate to provide user input to computer device 1005.

Storage/output device 1020 allows computer device 1005 to store information for additional processing or later retrieval (e.g., softcopy), to present information in various forms (e.g., hardcopy), or both. As an example, storage/output device 1020 may include a magnetic, optical, semiconductor, or magneto-optical drive capable of storing information on a desired medium and in a desired format. As another example, storage/output device 1020 may constitute a printer, plotter, or other output device to generate printed or plotted expressions of the information from computer device 1005. In some embodiments, in addition or as an alternative to storing information, storage device 1020 may provide information (e.g., previously stored information) to one or more components or parts of system 1000, for example, computer device 1005.

Computer-readable medium (or computer program product) 1025 interrelates structurally and functionally to computer device 1005. Computer-readable medium 1025 stores, encodes, records, and/or embodies functional descriptive material. By way of illustration, the functional descriptive material may include computer programs, computer code, computer applications, and/or information structures (e.g., data structures, databases or file systems). When stored, encoded, recorded, and/or embodied by computer-readable medium 1025, the functional descriptive material imparts functionality. The functional descriptive material interrelates to computer-readable medium 1025. In some embodiments, computer-readable medium 1025 is non-transitory, as desired.

In some embodiments, computer-readable medium 1025 may contain a database 1030. Database 1030 may have a structure such as described above, and/or may provide the functionality such as described above, as desired.

Information structures within the functional descriptive material define structural and functional interrelations between the information structures and computer-readable medium 1025 and/or other aspects of system 1000. These interrelations permit the realization of the information structures' functionality.

Moreover, within such functional descriptive material, computer programs define structural and functional interrelations between the computer programs and computer-readable medium 1025 and other aspects of system 1000. These interrelations permit the realization of the computer programs' functionality. Thus, in a general sense, computer-readable medium 1025 includes information, such as instructions, that when executed by computer device 1005, cause computer device 1005 (system 1000, generally) to provide the functionality prescribed by a process, computer program, software, database, method, algorithm, etc., as included (partially or entirely) in computer-readable medium 1025.

By way of illustration, computer device 1005 reads, accesses, or copies functional descriptive material into a computer memory (not shown explicitly in the figure) of computer device 1005 (or a separate block or memory circuit coupled to computer device 1005, as desired). Computer device 1005 performs operations in response to the material present in the computer memory. Computer device 1005 may perform the operations of processing a computer application that causes computer device 1005 to perform additional operations. Accordingly, the functional descriptive material exhibits a functional interrelation with the way computer device 1005 executes processes and performs operations.

Furthermore, computer-readable medium 1025 constitutes an apparatus from which computer device 1005 may access computer information, programs, code, and/or applications. Computer device 1005 may process the information, programs, code, and/or applications that cause computer device 1005 to perform additional or desired tasks or operations.

Note that one may implement computer-readable medium 1025 in a variety of ways, as persons of ordinary skill in the art would understand. For example, memory within computer device 1005 (and/or external to computer device 1005) may constitute a computer-readable medium 1025, as desired.

Alternatively, computer-readable medium 1025 may include a set of associated, interrelated, coupled (e.g., through conductors, fibers, etc.), or networked computer-readable media, for example, when computer device 1005 receives the functional descriptive material from a network of computer devices or information-processing systems. Note that computer device 1005 may receive the functional descriptive material from computer-readable medium 1025, the network, or both, as desired. In addition, input(s) and/or output(s) of system 1000 may be received from, or provided to, one or more networks (not shown), such as user's network 401.

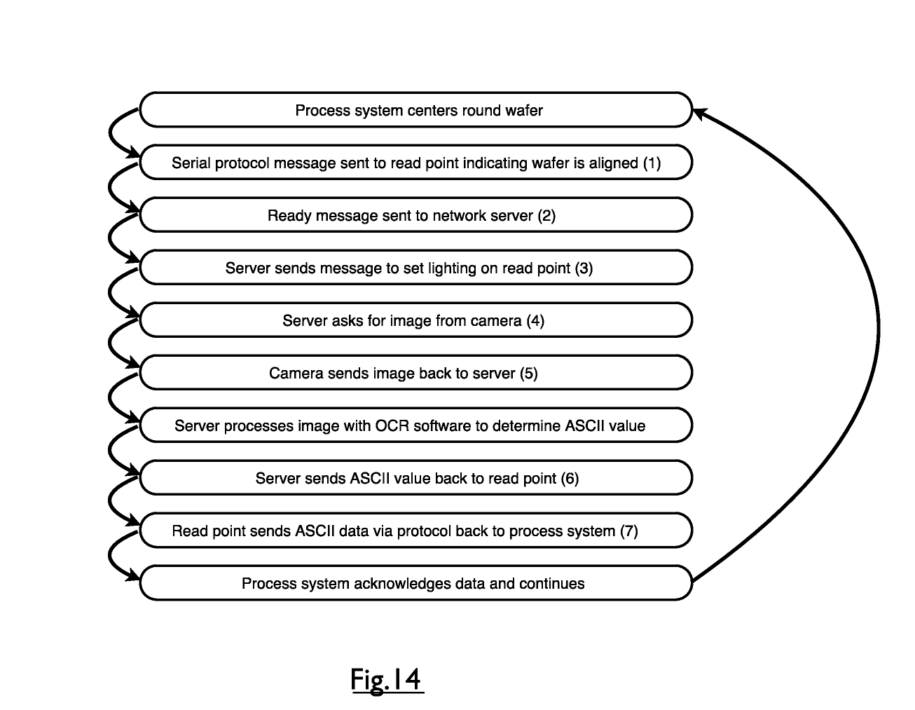

FIG. 14 shows a conventional logic flow diagram. The logic flow includes a process system centering a round wafer. Semiconductor wafers go through a testing process after they have been manufactured. This testing is carried out while the semiconductor devices are still in whole wafer form. The testers are called wafer probers and reside in a post wafer fabrication area called a probe floor. This testing (probing) is a relatively slow process and uses a relatively large number of wafer probers (typically in hundreds of machines) to match the manufacturing output of the device fabrication facility.

Due to the expense of purchasing a large number of machines, end users of these probers tend to not purchase these systems with all the options. One of the options that typically is not purchased with these probers is optical character recognition (OCR). The probers have a place to mount an OCR reader and an external communication port where the reader can be connected. Through prober configuration settings, the prober can be enabled to use an OCR. The OCR follows a specific published protocol to know when to perform OCR and how to report OCR results. Some conventional devices perform OCR on semiconductor wafers inside wafer-probing machines.

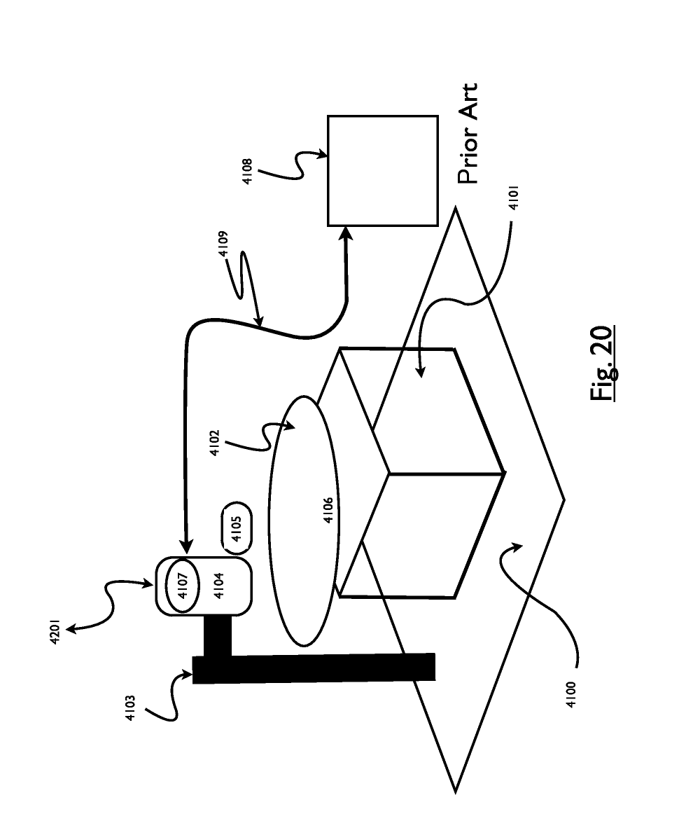

An example of a conventional read point device is shown in FIG. 20. The device in FIG. 20 includes system 4100 that includes a controller 4108 and a reading device 4104. A physical electrical connection exists between controller 4108 and reading device 4104 via cable 4109. Put another way, reading device 4104 is integrated within system 4100. Integration involves use of a published software protocol that the supplier of system 4100 provides.

The protocol is typically an ASCII message/response terminal sequence over RS-232. The equipment supplier of system 4100 designs the protocol into its controller 4108. The protocol defines with messages when the substrate is aligned and reading can take place. The protocol also defines when the reading is complete, so the substrate can move along in its process. The protocol therefore synchronizes the reading process. (Note that the wafer is not moving when the read step occurs.) Thus, manufacturers of system 4100 prepare and provide a published synchronized protocol to integrate reading into the aligning and centering process. As a result, the reading device is dependent on the details and configuration of system 4100.

Referring again to FIG. 14, a serial protocol message is sent to a read point, indicating whether the wafer is aligned. A ready message is sent to a network server. The server sends a message to set lighting on the read point. The server asks for an image from the camera. The camera sends an image to the sever. The server processed the image with OCR software to determine an ASCII value. The server sends the ASCII value back to the read point. The read point sends ASCII data via a protocol back to the process system. The process system acknowledges the data, and continues. Note that the system and the read point are coupled, and messages flow between them. Relatively large amounts of time are spent managing the message flow as a result of the coupling between the system and the read point. An individual state variable is also used for each process transaction.

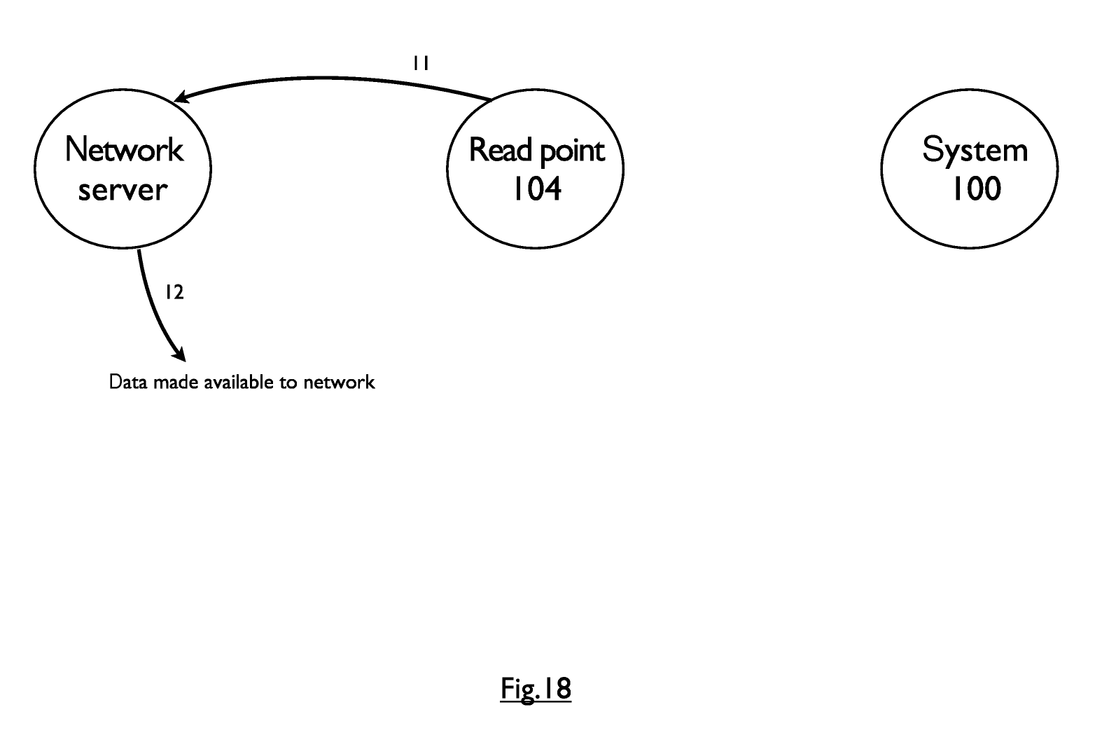

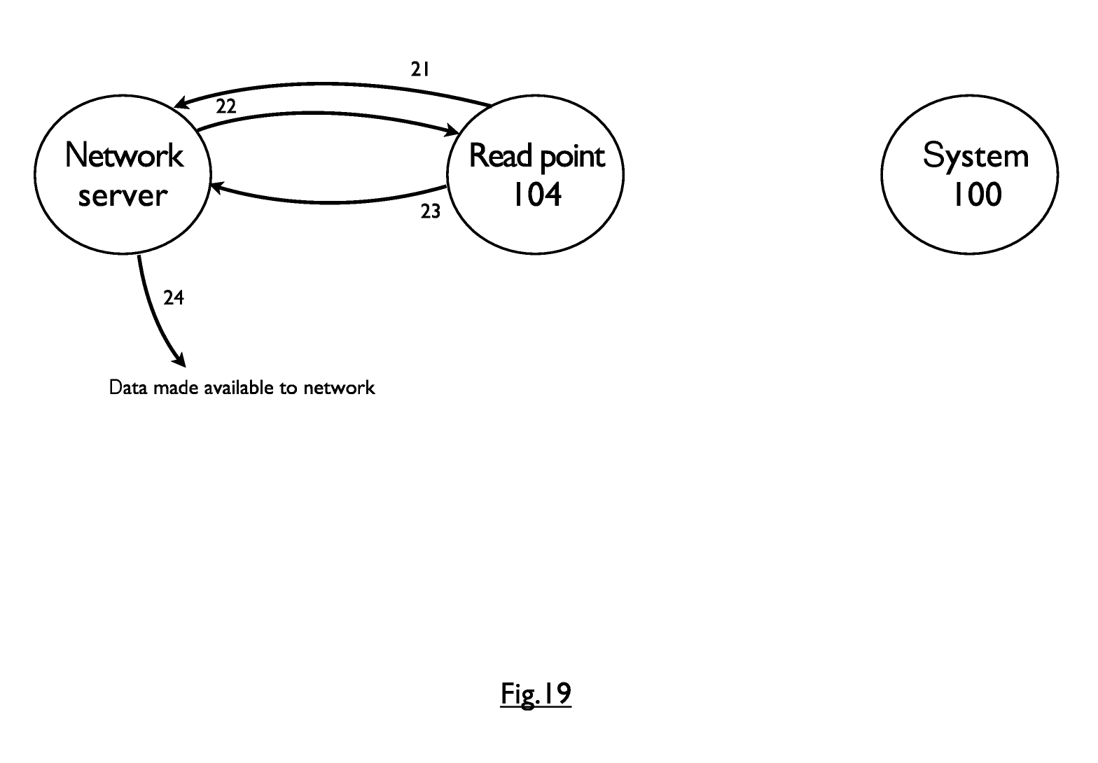

FIG. 15 and FIG. 16 show the logic flows or processes of two types of network configurations according to exemplary embodiments. Message numbers (see FIGS. 18 and 19) are included in parentheses for corresponding parts of the processes in FIGS. 15-16. Referring to FIG. 15, camera 104 determines the presence of an object (e.g., substrate 102). Camera 104 strobes light source 105 at a pre-calculated or desired rate and obtains one or more images or a video.

The image(s) or video is taken until the object is removed (or until a guaranteed time required). The image(s) or video is sent to network server, for example, the network servers described above according to exemplary embodiments. Referring again to FIG. 15, the server extracts desired images from the image(s) or video. The extracted images are sent to one or more OCR or image processing unit(s) to determine the result(s). The results are compared from different units and the best or higher quality or highest quality data are made available via the network.

Referring to FIG. 16, the logic flow or process proceeds as follows. Camera 104 determines the presence of an object (e.g., substrate 102) and sends a notification to server, for example, the servers described above according to exemplary embodiments. Referring again to FIG. 16, the network server uses lookup techniques (e.g., a lookup table) to determine appropriate or the best lighting and light field for the read point that corresponds to camera 104. The network server sends a message to configure the read point lighting. Camera 104 sets lighting conditions according to instructions from the network server.

Camera 104 strobes light source 105 at a pre-calculated or desired rate and obtains one or more images or a video. The image(s) or video is taken until the object is removed (or until a guaranteed time required). The image(s) or video is sent to network server, for example, the network servers described above according to exemplary embodiments. Referring again to FIG. 16, the server extracts desired images from the image(s) or video. The extracted images are sent to one or more OCR or image processing unit(s) to determine the result(s). The results are compared from different units and the best or higher quality or highest quality data are made available via the network.

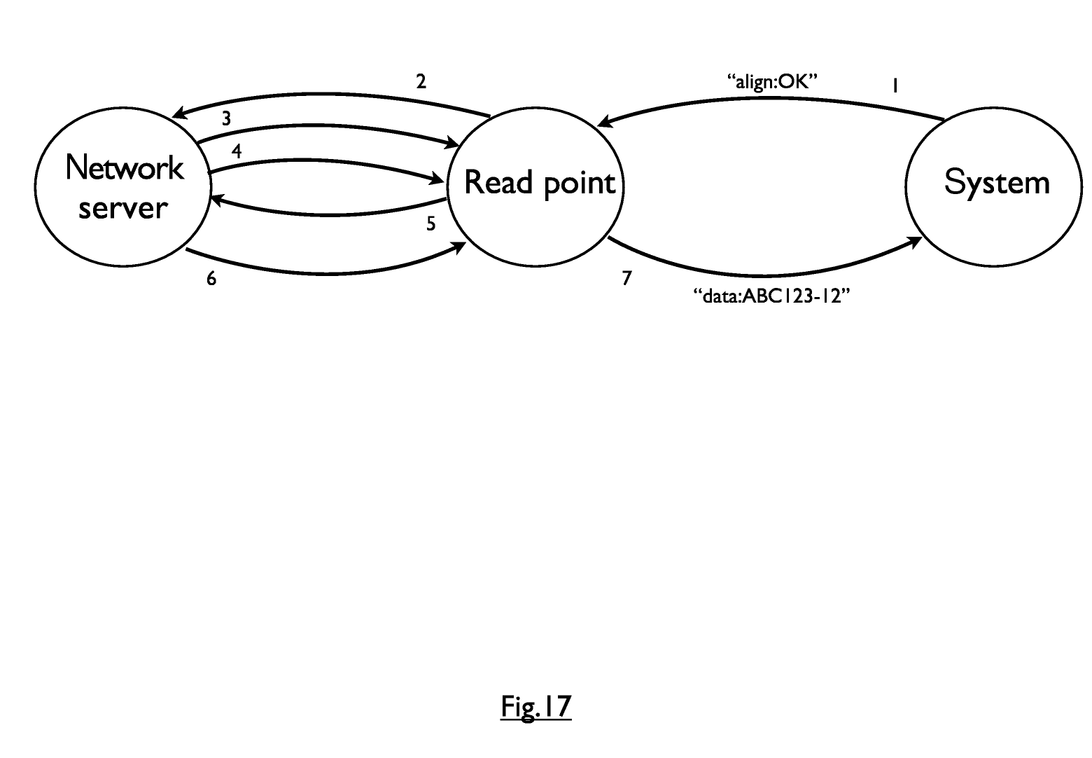

FIG. 17 shows the conventional flow of messages according to a prescribed protocol, which uses a coupling between the system and the read point. A sample of a protocol for message 1 “align:OK” indicates that the alignment is complete and an image can be taken. Messages 2-6 indicate communication between the network server and the read point according to the protocol. Message 7 responds after OCR operation is complete and the data (shown as “data:ABC123-12”) are returned.

FIG. 18 and FIG. 19 show the flows of messages of two types of configurations according to exemplary embodiments. As noted above, the message numbers in FIGS. 18-19 correspond to the numbers in parentheses shown in FIGS. 15-16, respectively. Generally speaking, the system (such as system 100) is decoupled from the read point (such as read point 104). Furthermore, no prescribed or required protocol is used for the flow of messages.

Note that the exemplary embodiments shown in FIGS. 18 and 19 use no logical state associated with any given transaction. Note that in exemplary embodiments, a one-OCR-to-one-prober correspondence is not used (see, for example, FIGS. 4 and 9). Rather, a single server based OCR system may be employed in exemplary embodiments instead of individual OCR readers at each prober. Note that reading devices or read points according to exemplary embodiments do not require an electrical connection (e.g., no cable) between system 100 and read point 104. As a result, no synchronization or protocol is used or defined between system 100 and read point 104. Thus, the reading operation (e.g., operation of read point 104) is made independent of system 100. This independence allows scope of exemplary embodiments to grow working merely with systems that have corresponding published protocols.

A variety of alternatives or variations may be used and are contemplated. For example, in some embodiments, instead of using a camera that can intelligently capture and buffer video and send the video to a server, an alternate method would be to have the video streamed over the network. In such a configuration, the read point cameras would be less complex because they would not perform any image processing. The server would analyze streams for when objects are in field of view and when to collect the frames. This configuration, however, may be less desirable than other embodiments in a manufacturing environment because of the larger network load because of the video stream(s).

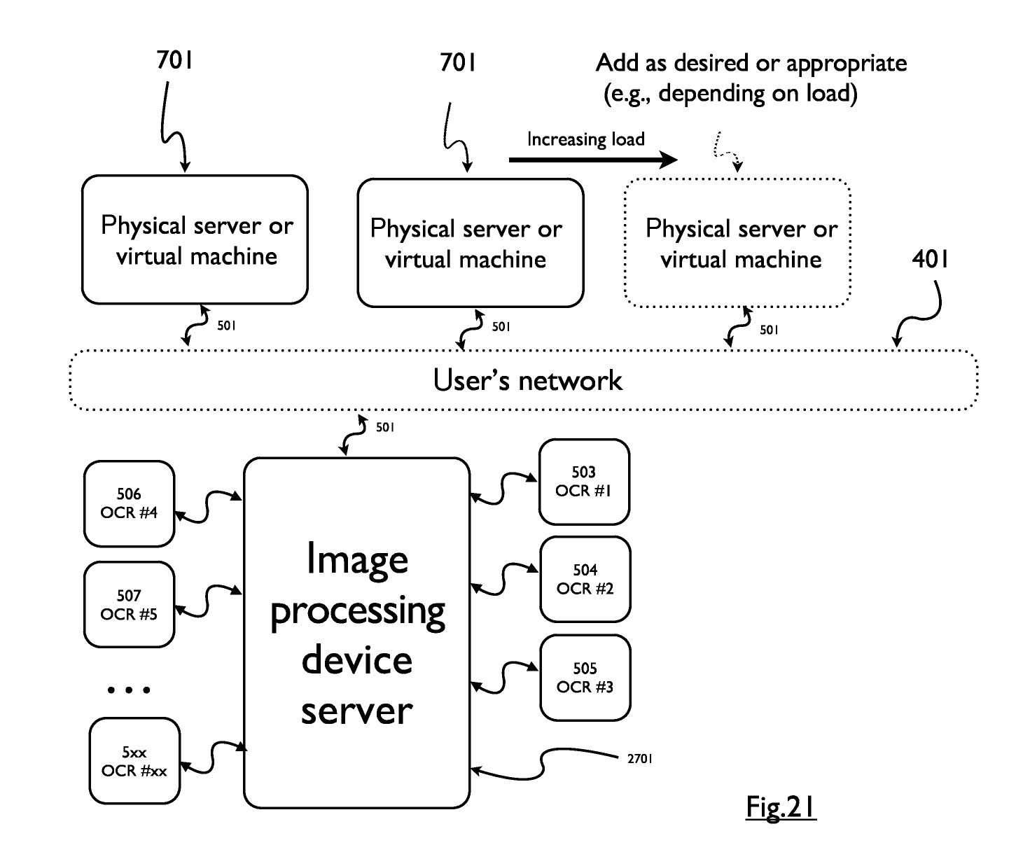

As an another example of an alternative, a variation on how servers using external image processing units are coupled or configured is shown in FIG. 21. This arrangement in FIG. 21 is an alternative that can improve the overall systems ability to scale itself based on load. A dedicated image processing device server 2701 is coupled to network 401. Server 2701 is not virtualized and scaled easily because it has external hardware (503-5xx) coupled to it. As load increases, additional 701 servers may be added to the network. As a result, server 2701 has a reduced workload, as it manages individual images being processed by the external devices and returns the results. Thus, a single server dedicated to managing image processing devices can service a relatively large number of scalable servers as the load changes.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired.

Furthermore, one may realize the functionality of a single block in several circuit blocks, as desired. The choice of circuit implementation depends on various factors, such as particular design and performance specifications for a given implementation. Other modifications and alternative embodiments in addition to those described here will be apparent to persons of ordinary skill in the art. Accordingly, this description teaches those skilled in the art the manner of carrying out the disclosed concepts, and is to be construed as illustrative only. Where applicable, the figures might or might not be drawn to scale, as persons of ordinary skill in the art will understand.

The forms and embodiments shown and described should be taken as illustrative embodiments. Persons skilled in the art may make various changes in the shape, size and arrangement of parts without departing from the scope of the disclosed concepts in this document. For example, persons skilled in the art may substitute equivalent elements for the elements illustrated and described here. Moreover, persons skilled in the art may use certain features of the disclosed concepts independently of the use of other features, without departing from the scope of the disclosed concepts.

1. An apparatus comprising:
a system for processing of an object having at least one surface, the object having a machine readable code on the at least one surface of the object; and
a reading device positioned to read the machine readable code on the at least one surface of the object independently of the system for processing of the object.
